(19) United States
(12) Patent Application Publication
(10) Pub. No.: US 2009/0196763 A1
(43) Pub. Date: Aug. 6, 2009

(54) Vertical axis wind turbines with blades for redirecting airflow

(75) Inventors: Ronald D. Jones, Bowling Green, KY (US); Gordon P. Smith, Bowling Green, KY (US); Stefano Mangano, Los Altos, KY (US)

Correspondence Address: William R. Lambert, 2365 Laura Lane, Mountain View, CA, 94043, US

(73) Assignee: Vinci-Tech Inc., Los Altos, CA (US)

(21) Appl. No.: 12/316,282

(22) Filed: Dec. 11, 2008

Related U.S. Application Data
(60) Provisional application No. 61/007,296, filed on Dec. 11, 2007.

(51) Int. Cl. F03D 3/06; F03D 11/00

(52) U.S. Cl. 416/90 R; 416/197 A

(57) ABSTRACT

Vertical axis wind turbines and Savonius blades incorporating an internal conduit for diverting a portion of an airflow incident on the blades are disclosed.

This application claims the benefit under 35 U.S.C. § 119(e) of U.S. Provisional Application Ser. No. 61/007,296, filed on Dec. 11, 2007, which is incorporated by reference in its entirety.

### FIELD

Vertical axis wind turbines and Savonius blades incorporating an internal conduit for diverting a portion of the airflow incident on the blades are disclosed.

### BACKGROUND

Wind turbines are well known for low cost power generation in areas of relatively consistent wind. Savonius wind turbines and Darrieus wind turbines are two basic types of vertical axis wind turbines. A Savonius system utilizes aerodynamic drag forces creating high torque at low rotational speeds. A Darrieus system uses aerodynamic lift forces to rotate at high speeds. A Savonius wind turbine is a type of vertical axis wind turbine in which the rotor blades or vanes are traditionally semi-cylindrical in semi-cylindrical shaped and coupled to a central shaft. The principle of operation of Savonius wind turbines is based on the difference in the drag forces of semi-circular surfaces extending horizontally on a rotor, where one semi-circular surface is oriented so as to be concave while the counterpart surface is oriented to be convex. When an air stream is directed over the surfaces the drag difference between the concave and convex surfaces cause the rotor to rotate.

Multiple Savonius blades can be incorporated into a system to increase the amount of wind energy that may be converted to electrical energy for a given area. Multiple blade systems typically use blades having the same dimensions and therefore may not be efficient for all wind conditions. Furthermore, structural loads on a wind turbine can vary considerably in the conditions of use and therefore it is desirable to incorporate features that are capable of reducing excessive loads in certain wind conditions.

### SUMMARY

Accordingly, there is a need for a robust wind turbine design that can operate efficiently and safely in all wind conditions, that is easy to transport and install in multiple configurations, and that can be aesthetically matched to the surrounding landscape.

In a first aspect, vertical axis wind turbines are disclosed comprising a first rotating shaft coupled to a first generator; a first plurality of hubs connected to the first rotating shaft and vertically disposed at intervals along the length of the first rotating shaft; and a first plurality of blades connected to each of the first plurality of hubs.

In a second aspect, Savonius blades for redirecting a portion of an airflow incident upon the blades are disclosed comprising a cup section and a funnel section comprising an internal conduit fluidly connected to the cup section.

In a third aspect, vertical axis wind turbines are disclosed comprising a vertical rotating shaft coupled to a first generator; a plurality of hubs connected to the rotating shaft and disposed at intervals along the length of the rotating shaft; and a plurality of blades connected to the plurality of hubs, wherein at least some of the plurality of blades comprise an internal conduit adapted to divert a portion of an airflow incident on the plurality of blades to provide a redirected airflow.

These and other features of the present disclosure are set forth herein.

### BRIEF DESCRIPTION OF THE DRAWINGS

The skilled artisan will understand that the drawings, described herein, are for illustration purposes only. The drawings are not intended to limit the scope provided by the present disclosure.

FIG. 1 shows cross-sectional views of an embodiment of a vertical axis wind turbine with and without blades attached.

FIG. 2 shows a perspective view of an embodiment of a vertical axis wind turbine comprising Savonius blades having different dimensions and having a substantially arboreal shape.

FIG. 3 shows an exploded view of an embodiment of a vertical axis wind turbine.

FIG. 4 shows an example of a propeller useful for generating power from a diverted airflow.

FIG. 5 shows a schematic diagram of an embodiment of a wind turbine in which blades are attached to a central rotating shaft (5A) and an embodiment in which blades are attached to a rotating shaft concentric to a central non-rotating frame (5B).

FIG. 6 shows embodiments in which two independent rotating shafts are concentric to a non-rotating frame (6A); and in which a rotating shaft is concentric to a rotating shaft (6B).

FIG. 7 shows examples of blade configurations.

FIG. 8 shows a view of an embodiment of a vertical axis wind turbine having a Darrieus rotor upper section and a Savonius rotor lower section.

FIG. 9 shows an exploded view of an embodiment of a blade having cup, branch, and trunk sections.

FIG. 10 shows a dimensioned schematic diagram of an embodiment of a cup section.

FIG. 11 shows a plurality of blades connected to a hub, which is connected to a rotating shaft.

FIG. 12 shows a perspective exploded view of a plurality of blades connected to a rotating shaft and details of blade sections.

FIG. 13 illustrates the airflow in an embodiment of a blade comprising an internal duct.

FIG. 14 illustrates the path of redirected airflow through vertically adjoining trunk sections along a length of a rotating shaft.

FIG. 15 shows different perspective views of an embodiment of a cup.

### DETAILED DESCRIPTION

Reference is now made in detail to embodiments of the present disclosure. The disclosed embodiments are not intended to be limiting of the claims. To the contrary, the claims are intended to cover alternatives, modifications, and equivalents.

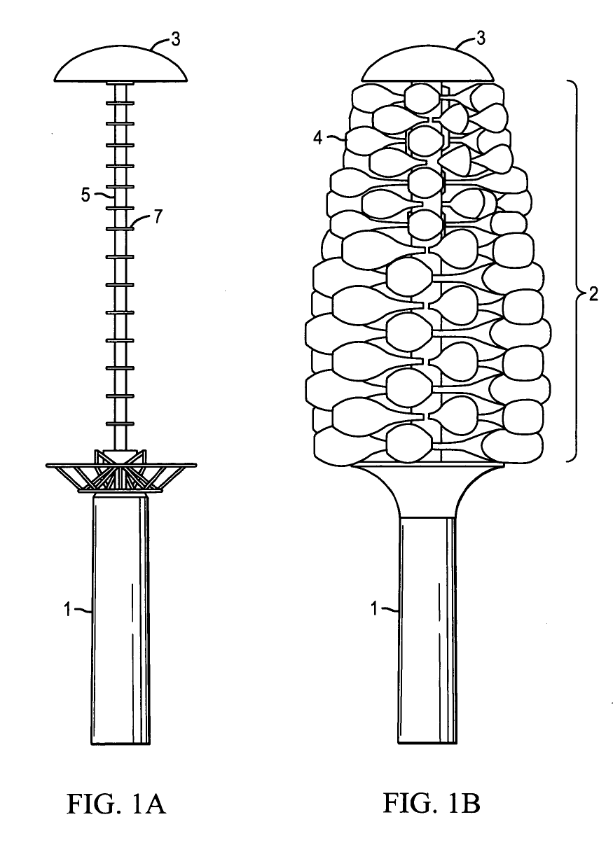

Vertical axis wind turbines provided by the present disclosure include a mounting structure, a rotating shaft, a plurality of hubs with multiple blades connected to the rotating shaft, and a first generator coupled to the rotating shaft. Cross-sectional views of an embodiment of a wind turbine provided by the present disclosure with and without the blades are shown in FIG. 1. As shown in FIG. 1, a vertical axis wind turbine can include a mount 1, a rotor section 2, and a bonnet 3. Mount 1 secures the wind turbine to a base and can serve to raise the rotor section into an airflow. For larger installations, mount 1 may be fabricated from any appropriate material such as a composite/metal construction and may be modular such as in 5-meter sections or other appropriate length to facilitate transport and assembly. For smaller installations, a mount may only be as high as needed to lift the lowest level of blades above the mounting surface. For example, in installations in which a wind turbine is mounted on a structure such as the roof of a building, the blades are already lifted into the wind and a shorter mount may be appropriate. Mount 1 may house an assembly for securing a base frame or non-rotating frame, one or more rotating shafts, a braking system, a drive generator and/or other electrical and/or mechanical system components.

A wind turbine may be capped with bonnet 3 to provide, for example, environmental protection for the mechanical and electrical components within the frame or shaft, to provide lightning protection, to provide exterior lighting and/or to augment the aesthetics. The dimensions of bonnet 3 may be selected as appropriate, for example, matched to the overall dimension of the wind turbine to provide profile that is aesthetically matched to landscape at the site of use.

The overall dimensions of wind turbines provided by the present disclosure may vary depending upon a number of factors including the output power, wind conditions at the use site, and aesthetic considerations. For example, for a 30 kW system, the dimensions of the rotor section may be about 15 meters in length, about 9 meters at the base, and about 4 meters toward the top. For a 100 kW system, the dimensions of the rotor section may be about 30 meters in length, about 16 meters at the base, and about 8 meters toward the top. Other dimensions may be used as appropriate depending, for example, on the desired output power and the conditions of use. For example, small systems of a few kW or tens of kW may be from about 1 meter to about 20 meters high.

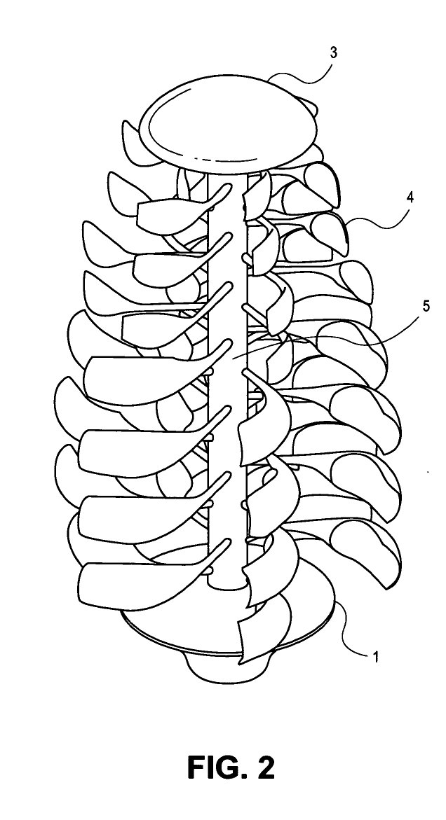

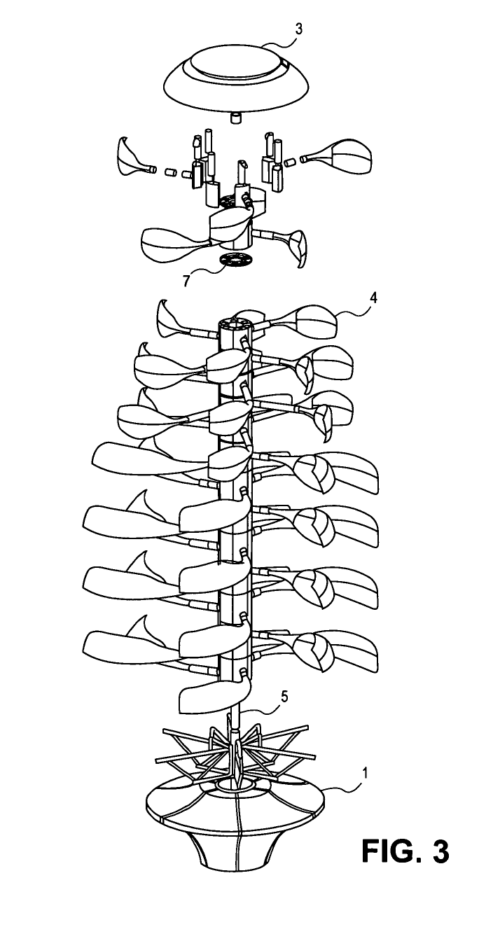

Rotor section 2 comprises a plurality of hubs 7 with a plurality of blades 4 mounted to a rotating shaft 5. A cross-sectional view of an embodiment of a rotor section is shown in FIG. 1, a perspective view in FIG. 2, and an exploded view in FIG. 3.

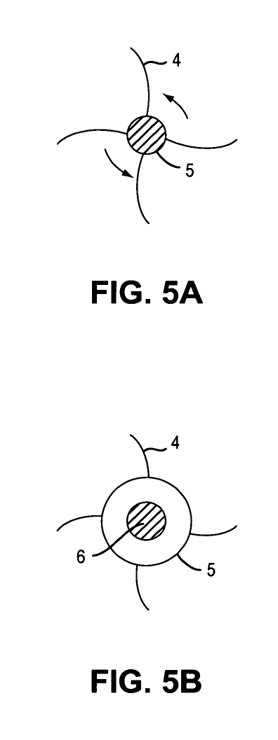

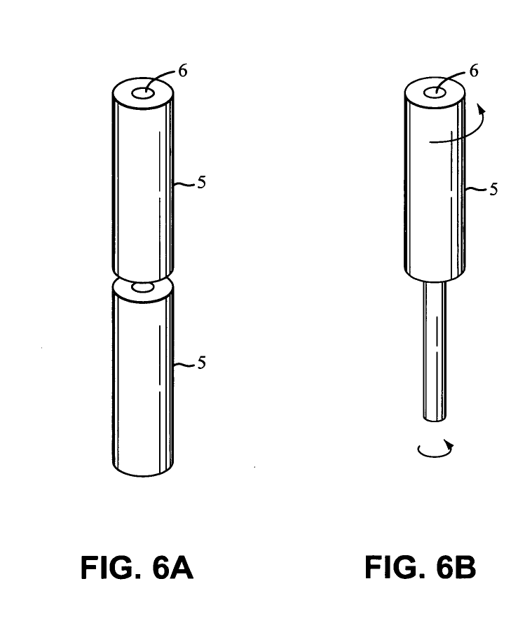

Rotating shaft 5 provides support for plurality of blades 4 and couples the torque produced by rotation of plurality of blades 4 to an electrical generator. Multiple configurations of rotating shaft 5 are encompassed. For example, referring to FIG. 5A, rotating shaft 5 may also serve as the central support member such that rotating shaft 5 and plurality of blades 4 rotate as a single unit. Alternatively, rotating shaft 5 may be disposed concentrically around a central non-rotating frame 6 (FIG. 5B). In certain embodiments, a wind turbine may comprise more than one rotating shaft. In such embodiments, for example, more than one rotating shaft 5 may be concentrically disposed around a central non-rotating frame 6 (FIG. 6A). In other embodiments, both the central shaft 6 and a concentric frame 5 rotate (FIG. 6B).

Wind turbines provided by the present disclosure may have one, two, or more than two rotating shafts, with each shaft coupled to a separate generator.

Non-rotating frames and rotating shafts may be segmented or modular to facilitate transportation and assembly. For example, a non-rotating frame and rotating shaft may be segmented in about 3- to about 7-meter long sections. Adjoining sections may be connected using any appropriate method.

In embodiments comprising more than one rotating shaft, each of the rotating shafts may be configured to rotate in the same direction or in the opposite direction to another rotating shaft.

In wind turbines with more than one rotating shaft, each rotating shaft may be coupled to a separate electrical generator. In certain embodiments comprising two or more rotating shafts, the rotating shafts may be coupled to the same generator, which may be a dual rotor generator. Typical generators use a stator/rotor combination in which one rotor moves about a stationary stator. For example, the center rotor of the generator rotates and the outer stator is stationary. In a dual rotor generator both the center and the outer parts rotate. As applicable to a wind turbine comprising two rotating shafts coupled to a dual rotor generator, one rotating frame shaft drives the interior generator rotor, and a second rotating shaft drives the outer generator rotor. In such embodiments, two counter-rotating shafts can produce coupled to a dual rotor generator can generate a higher rotation speed and thereby produce higher output power than two shafts coupled to separate generators.

Hubs are used to connect blades 4 to rotating shaft 5. As shown in FIG. 1, multiple hubs 7 are disposed at intervals along the length of rotating shaft 5. The intervals between adjacent hubs may be regular or variable along the length of rotating shaft 5. The intervals may be selected so as to accommodate the dimensions of the blades. For example, in certain embodiments in which blades having smaller dimensions are disposed toward the top of rotating shaft 5, the distance between hubs 7 toward the top of rotating shaft 5 may be shorter than the distance between hubs 7 disposed toward the bottom of rotating shaft 5. In certain embodiments, the interval between adjacent hubs may be from about 0.5 meters to about 3 meters; and in certain embodiments, from about 1 meter to about 2 meters. In FIG. 1, an embodiment in which multiple hubs 7 are spaced at varying intervals along the length of rotating shaft 5 is shown, with intervals between hubs 7 toward the top of rotating shaft 5 being smaller than the intervals toward the bottom of rotating shaft 5. The intervals accommodate the larger blades toward the bottom of the turbine and the smaller blades toward the top of the turbine. In certain embodiments, in some parts of a rotor section hubs may be evenly spaced, and in other sections of the rotor the space between adjacent hubs may vary.

Hubs 7 are rigidly attached to rotating shaft 5 and to blades 4 and are intended to carry the torque from blades 4 to rotating shaft 5. A wind turbine may have from 1 hub to about 20 hubs. The number of hubs will be determined by such factors as the wind conditions at the site of installation, the desired output power, the size of the blades, and by aesthetics. Each hub 7 serves as an attachment point for multiple blades 4. For example, in certain embodiments, from 2 to 12 blades may be attached to a single hub 7, and in certain embodiments, from 3 to 6 blades may be attached to a single hub 7. In certain embodiments, 2, 3, 4, 5, 6, 7, 8, 9, 10, 11, or 12 blades are attached to a hub. The number of blades attached to a particular hub may vary along the length of the rotating shaft. For example, from 3 to 4 blades may be attached to a single hub disposed toward the bottom of a rotating shaft and from 5 to 8 blades may be attached to a single hub disposed toward the top of the rotating shaft. The blades attached to the same hub may have the same dimensions or may have different dimensions. For example, some blades attached to the same hub may be wider or narrow than other blades attached to the same hub and/or may extend closer or farther from the rotating shaft than other blades attached to the same hub. The hubs are sectioned such that individual blades may be attached, removed, and/or replaced without having to disassemble the entire unit. The modularity of the hubs and blades facilitate assembly, repair, and the ability to adapt a wind turbine to a particular environment of use and/or to modify the wind turbine after initial installation.

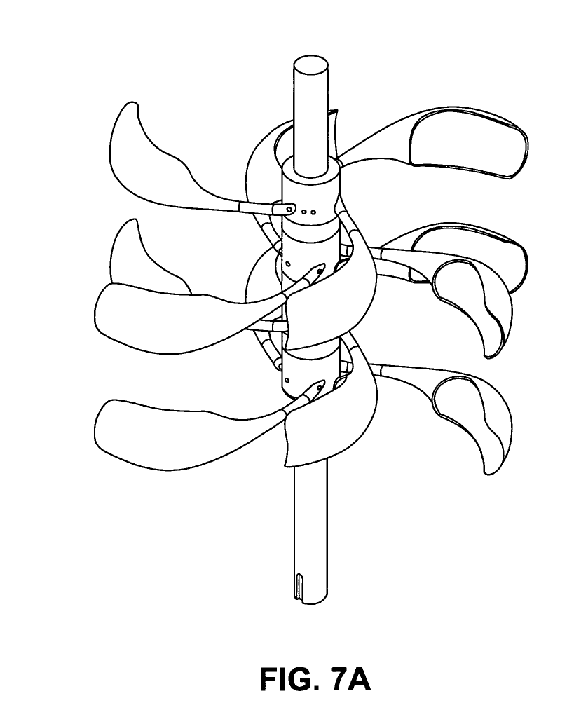

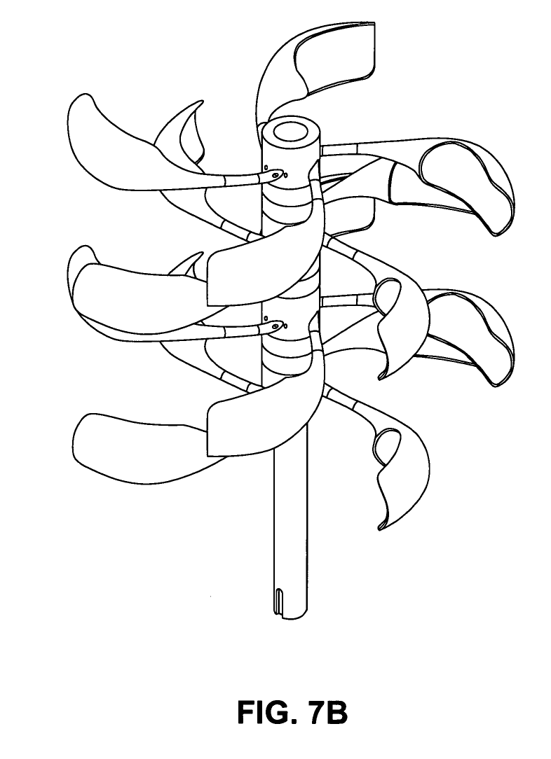

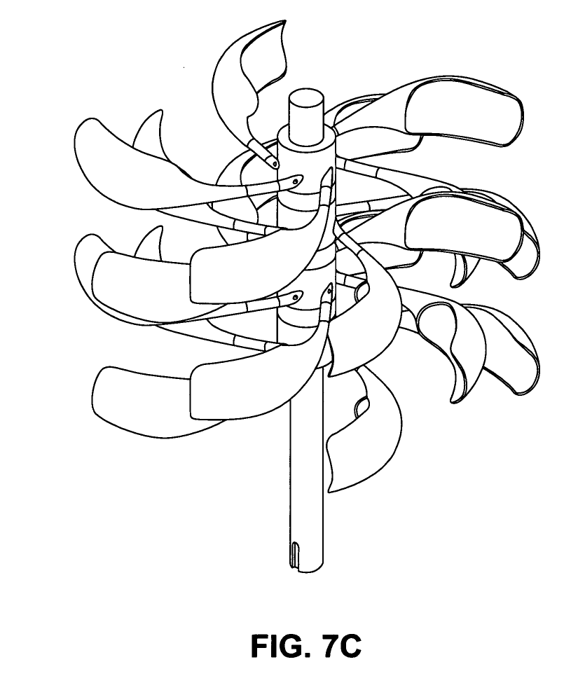

Blades connected to adjacent hubs may be vertically oriented to optimize the conversion efficiency of the wind turbine. For example, in certain embodiments, when viewed from top down, blades connected to a hub may be oriented directly above/below the blades of the next adjacent hub as shown in FIG. 7A. In certain embodiments, blades connected to adjacent hubs may be oriented orthogonally (FIG. 7B), and in certain embodiments, blades connected to adjacent hubs may be offset at an angle with respect to each other (FIG. 7C).

The relative vertical orientation of blades on adjacent hubs may be similar along the length of a rotating shaft, may be different, or may be similar or different in different parts of the rotor section. In general, the relative orientation of blades with respect to blades connected to adjacent hubs may be selected to optimize the conversion efficiency of a particular wind turbine in the conditions of operation.

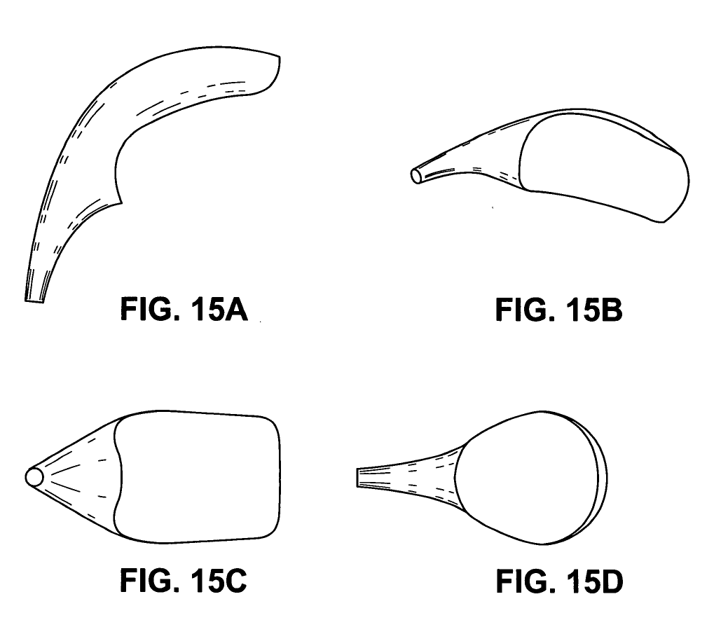

The spacing between adjacent hubs and the blades attached to the adjacent hubs can be selected to minimize turbulence and maximize the surface area of the blades, which in turn can optimize the conversion efficiency of the wind turbine. In general, the surface area of the blades will be maximized when the cups of vertically adjacent blades are nearly touching (e.g., FIG. 7C), however this can produce unacceptable turbulence. Conversely, when adjacent hubs and blades are spaced far apart, turbulence will be minimized, however, the surface area of the blades will be low. An optimum separation between adjacent hubs and blades can also be affected by the wind conditions. The separation between adjacent hubs and blades can be selected to optimize the power conversion efficiency of a wind turbine depending at least in part on the blade dimensions, the number of blades attached to adjacent hubs, the cup dimensions, the desired output power, and the wind conditions at the site of installation. Wind conditions to consider include average wind conditions, high wind velocities at which turbulence is more likely to occur, gusting wind conditions, and the angle at which wind impacts the wind turbine such as when wind is incident at an upward angle to the turbine. Furthermore, the modular design of wind turbines provided by the present disclosure facilitates optimization after the wind turbine is installed. In certain embodiments, the distance between adjacent hubs can be selected such that the cups of adjacent blades are separated by about ½ cup widths, about 1 cup width, about 1½ cup widths, about 2 cup widths, about 2½ cup widths, and in certain embodiments about 3 cup widths; where cup width refers to the width of one of the cups of a blade connected to either of the two adjacent hubs. In certain embodiments, cup width refers to the width of the widest cup of a blade connected to either of the two adjacent hubs. Referring to FIG. 15C, the width or height of a cup is the vertical dimension of the concave portion open to an incident airflow. In certain embodiments, the distance between adjacent hubs can be about 1½ cup widths, about 2 cup widths, about 2½ cup widths, about 3 cup widths, about 3½ cup widths, and in certain embodiments about 4 cup widths; where cup width refers to the width of one of the cups of a blade connected to either of the two adjacent hubs. Other separations between adjacent hubs are encompassed within the scope of the disclosed embodiments.

In embodiments in which a wind turbine has a rigid, non-rotating frame, hubs 7 may include bearings to provide connection and separation of the non-rotating center frame to the externally concentric rotating shaft.

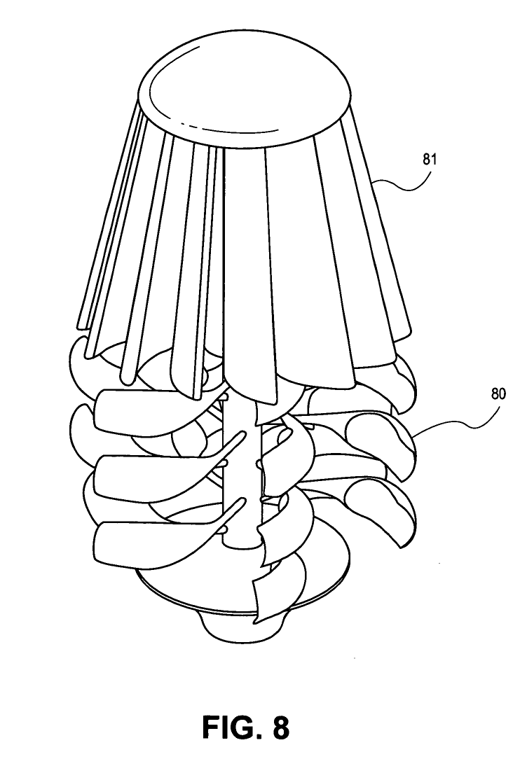

Blades provided by the present disclosure may be Savonius-type blades or Darrieus-type blades. Each of the multiple blades attached to a rotating shaft is of the same type. In wind turbines comprising more than one rotating shaft, each of the plurality of blades attached to each of the rotating shafts may be of the same type or a different type. For example, for two rotating shafts, each of the plurality of blades attached to the first rotating shaft may be a Savonius blade, and each of the plurality of blades attached to the second rotating shaft may be either a Savonius blade or a Darrieus blade. Savonius blades may be on the upper section of a wind turbine or the lower section of the wind turbine, and the Darrieus blades may be attached to the other of the upper or lower sections. Darrieus blades generally can be lighter than Savonius blades, and therefore it is generally desirable that Darrieus blades be attached to the upper section of the wind turbine, and Savonius blades attached to the lower section of a wind turbine. An example of a wind turbine comprising a lower rotor section comprising Savonius blades 80 and an upper rotor section comprising Darrieus blades 81 is shown in FIG. 8. A combination of Savonius type turbine with a Darrieus type turbine uses two separate rotating shafts. The shafts can rotating in the same direction or in opposite directions. FIG. 8 shows a wind turbine in which the Savonius blades and the Darrieus blades rotate in opposite directions. When counter-rotating shafts are used, each of the shafts can be coupled to a separate rotor of a dual rotor generator. Such a configuration can be used to overcome the generally low rotational speeds of typical Savonius type wind turbines, and thereby increase the efficiency of power generation.

In certain embodiments, each of the plurality of blades attached to each of the rotating shafts is a Savonius blade.

Many types and designs of Savonius blades are known in the art and may be used in wind turbines provided by the present disclosure. A rotor section may comprise one or more types or designs of Savonius blades. Furthermore, each hub may be connected to the same type or design of Savonius blade, and adjacent hubs may be connected to the same type or design of Savonius blade, or to a different type or design of Savonius blade.

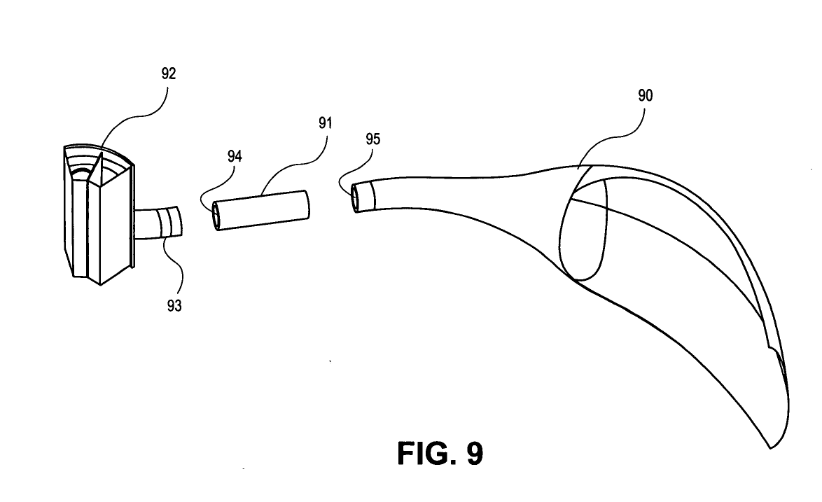

As illustrated in FIG. 9, blades comprise a cup section 90, a branch section 91, and a trunk section 92.

Blades can have dimensions from about 1 meter to about 2 meters in height; from about 2 meters to about 6 meters in length; and from about 1.5 meters to about 3 meters in depth; where height refers to the vertical dimension of the blade mounted on a rotating shaft when viewed on axis, length refers to the distance from trunk 92 to the tip of cup 90, and depth refers to the horizontal dimension of the blade mounted on a rotating shaft when viewed on axis (from cup 90 toward trunk 92).

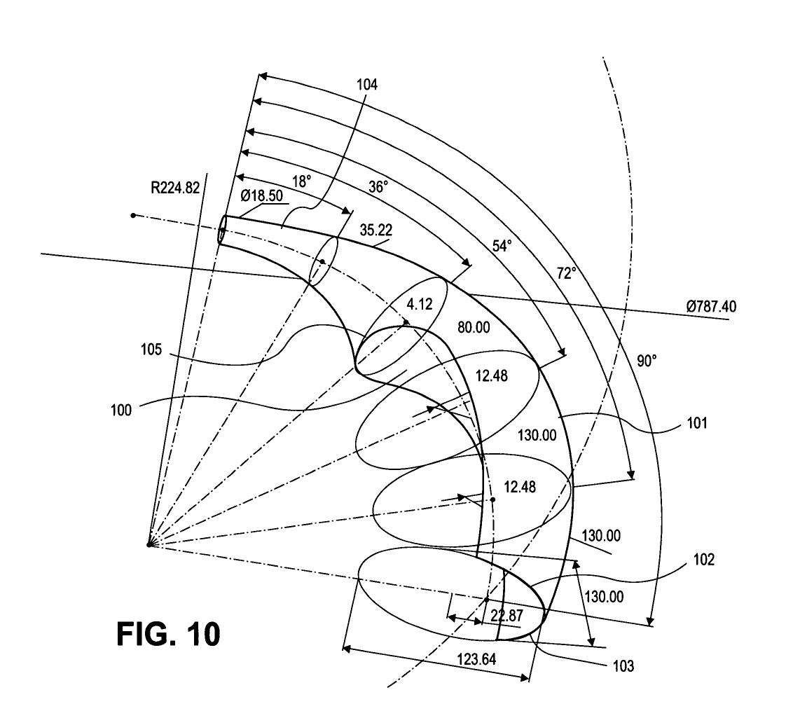

A schematic view showing relative dimensions of an example of a cup section is shown in FIG. 10 (linear dimensions are in inches). The overall dimensions of a cup may be different than those shown in FIG. 10. For example, the dimensions of a cup section may be from about 40 inches to about 80 inches in height; from about 60 inches to about 110 inches in width; and from about 40 inches to about 90 inches in length. In certain embodiments, the dimensions of a small cup may be about 40 inches to about 55 inches in height; from about 60 to about 75 inches in depth; and from about 50 to about 80 inches in length. In certain embodiments, the dimensions of a large cup may be about 60 inches to about 75 inches in height; from about 90 to about 110 inches in depth; and from about 70 to about 90 inches in length. Other overall cup dimensions are within the scope of cup sections provided by the present disclosure. It is desirable that the overall shape and dimensions of a cup may in part be determined by aerodynamic considerations to optimize the efficiency of transfer of wind energy to the rotating shaft. The overall shape of the cup is also in part determined to roughly simulate leaves and branches of natural trees. The overall shape of the cup shown in FIG. 10 may be linearly scaled for smaller or larger cups to have the same relative dimensions as those shown in FIG. 10.

As shown in FIG. 10, a cup has the shape of an open-faced curved funnel. Concave surface 100 and convex surface 101 are curved and toward the leading edge 102 of the cup define a scoop 103 and taper toward a funnel section 104. Concave and convex surfaces 100/101 are open toward leading edge 102 and close at lip 105 toward funnel section 104. As illustrated in FIG. 10, concave and convex surfaces 100/101 have a variable radius of curvature.

Funnel section 104 may be solid or in certain embodiments may comprise an internal conduit. The internal conduit may be used to channel at least a portion of the airflow incident on concave surfaced 100 from the cup to provide a channel for redirected airflow. Scoop 103, lip 105, and the internal conduit of a cup may be dimensioned to redirect from about 10% to about 90% of the total airflow incident on concave surface 100 through the internal conduit. In certain embodiments, a cup may be dimensioned so as to redirect from about 20% to about 50% of the total airflow incident on concave surface 100 through the internal conduit.

The surfaces of a cup section may be smooth and/or may contain structural features. Such features may serve to increase the mechanical strength of the cup and/or optimize the aerodynamics of the airflow over the surface of the cup. For example, a cup may contain ribs to enhance the mechanical strength and/or a profiled surface to improve aerodynamic performance such as reducing surface drag. Similarly, all or parts of the edges defined by the interface of concave and convex surfaces may include features to enhance the aerodynamics, such as, for example, serrations or undulations.

In FIG. 10 a cup is shown having a relatively consistent cross-sectional area over a substantial length, e.g., from leading edge 102 toward lip 105. However, the cross-sectional area may vary, for example, being larger or narrower toward the leading edge 102 than at lip 105. Different perspective views of a cup are shown in FIG. 15.

A cup may be oriented with respect to the rotating shaft for maximum efficiency. For example, the central axis of a cup may be oriented substantially vertical. In certain embodiments, the central axis of a cup may be oriented from about 0° to about 25° with respect to vertical, and in certain embodiments from about 0° to about 15° with respect to vertical.

Blade components may be fabricated using any appropriate material and technology. For example, blade components may be of a composite structure, with fiber-reinforced epoxy skins. Examples of composites include short fiber composites, long fiber composites, nanofiber composites, laminates, sandwich structures, and honeycomb structures. Composites include material in which reinforcing materials such as fibers are imbedded in a polymer matrix. Examples of fiber reinforcement materials include carbon, glass, aramid fibers, and the like. Examples of matrix material used in composites include polymers such as vinyl ester, epoxy, and polyester. In certain embodiments, the material may be selected from a lightweight composite sandwich, laminate, or honeycomb structure. Technologies useful in manufacturing composites include hand lay-up, compression molding, resin transfer molding and filament winding. Furthermore, the separate blade elements may be fabricated using different materials and technologies. For example, the cup and branch sections may be fabricated using light weight composite materials, and the trunk section may be fabricated from extruded metal sections.

Referring to FIG. 9, branch section 91 connects cup section 90 to trunk section 92. Branch 91 may be solid or may incorporate an internal conduit 94 for channeling airflow from cup section 90 via conduit 95 to trunk section 92. The dimensions of the internal conduit may be selected based on considerations such as mechanical strength and desired airflow volume. The cross-sectional shape of an internal conduit may be any appropriate shape such as round or oval, and may be selected to correspond to the dimensions of the internal conduit within the funnel section of the cup and with a branch connection on the trunk. Branch 91 may be fabricated from any appropriate material, such as for example, light weight tow-wound laminate. In certain embodiments, a branch section may be from about 0.3 meters to about 1.4 meters in length. The length of a branch section may be selected to establish the distance of a blade cup from the rotating frame to which it is attached to increase the torque and aesthetic appearance.

Trunk section 92 connects cup section 90 and branch 91 to a hub. Accordingly, trunk 92 comprises a branch connection 93 for connecting branch section 91 and a section for connecting to at least one hub, and in certain embodiments, two adjacent hubs. Trunk section 92 may be any appropriate dimension to provide structural strength to the assembly under use conditions. In certain embodiments, the vertical length of trunk 92 will be the distance between adjacent hubs to which it is connected. In certain embodiments, the vertical length of trunk 92 will be less than the distance between adjacent hubs. In such embodiments, additional trunk sections that are not connected to blades may be used to fill the space between adjacent hubs. In this way the separation between adjacent hubs may be varied to optimize the performance of a wind turbine.

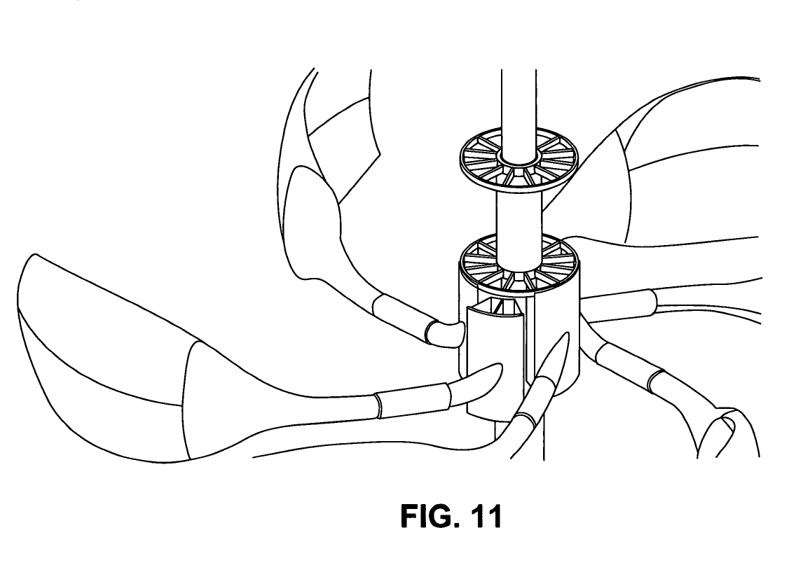

The angle at which branch connection 93 is attached to the trunk body may be selected based on mechanical strength and aerodynamic considerations. For example, as shown in FIG. 11, the branch connection is curved and is directed off the central axis of the rotating shaft. Also, as shown in FIG. 11, the trunk sections are wedge shaped such that when multiple trunks are assembled on a hub, the trunks fill the space surrounding the central rotating shaft. Branch connection 93 may be solid or may comprise an internal conduit.

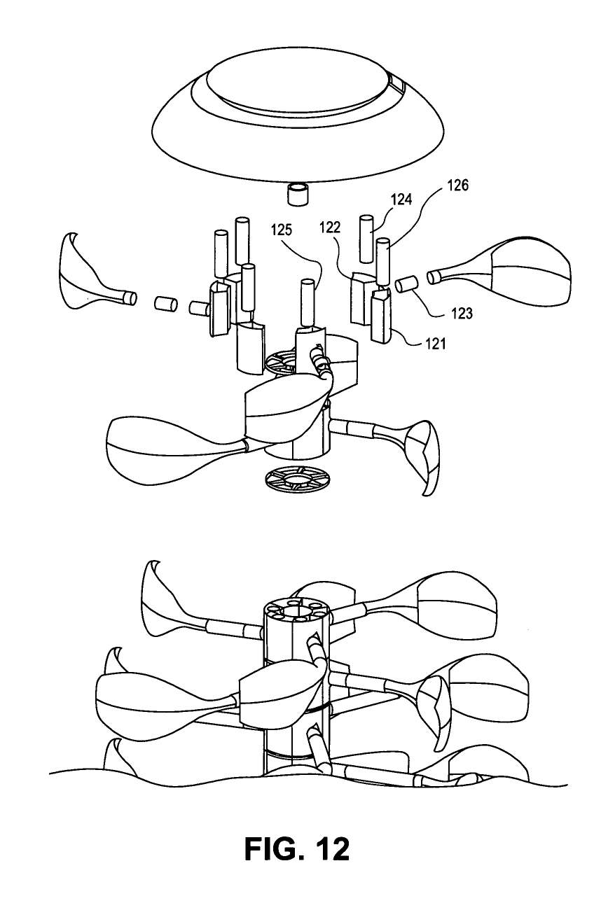

A trunk section may be solid or contain one or more hollow sections. In certain embodiments in which at least a portion of the trunk section is hollow, the hollow section(s) may be adapted as conduit(s) for channeling the redirected airflow from a cup section. An embodiment of a trunk comprising internal conduits for channeling redirected airflow is shown in FIG. 12. In this embodiment, the trunk body comprises hollow sections 121 and 122. Hollow section 122 comprises branch connection 123, which is connected to conduit 124. Conduit 124 is vertically disposed within hollow section 122 and is configured to vertically channel redirected airflow either up or down the vertical axis of the wind turbine.

In certain embodiments, airflow incident on a blade can be redirected. The airflow can be redirected to reduce mechanical stress on the wind turbine in certain environmental conditions and/or to generate power. In such embodiments, the cup, branch, and trunk sections of at least some of the blades of a wind turbine provided by the present disclosure comprise an internal conduit. Airflow incident on a cup can be directed to an internal conduit in the funnel section, through an internal conduit in the attached branch, and into an internal conduit in the attached trunk. The amount of redirected airflow may be from about 10% to about 90% of the total airflow incident on a cup, and in certain embodiments, from about 20% to about 50% of the total airflow incident on a cup.

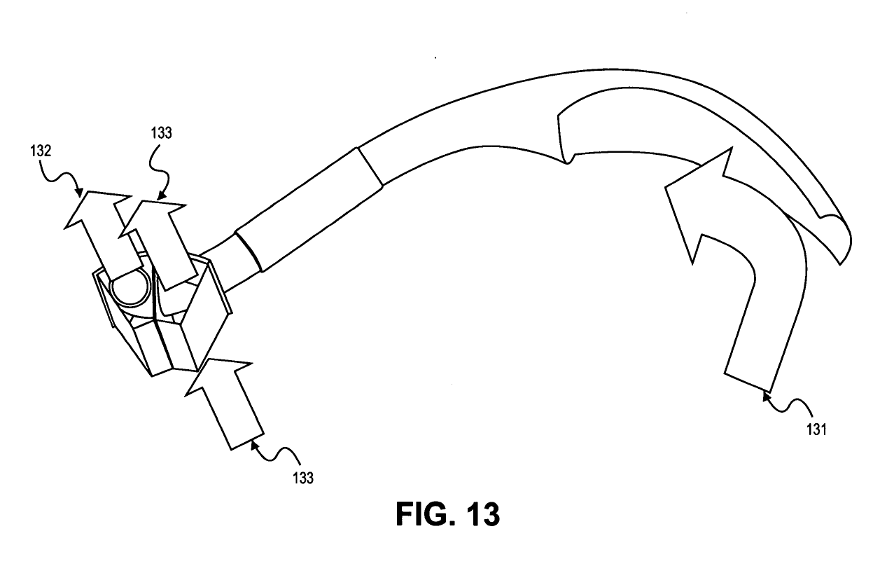

A schematic of an incident airflow being redirected by a blade is shown in FIG. 13. A portion of an airflow 131 incident on the cup section of a blade is redirected into the branch section. Redirected airflow 132 is channeled through the branch section and exits an extension of the branch section within the trunk, which is configured to direct the predominantly horizontal incident airflow from the cup vertically, either upward (as shown) or downward. Redirected airflow 132 can pass to an adjoining truck section. Redirected airflow 133 from an adjoining trunk section also passes through the trunk, from a lower to an upper trunk section (or in embodiments in which the direction of redirected airflow 132 is downward, from an upper trunk section to a lower trunk section).

Referring to FIG. 12, redirected airflow from conduit 124 may be channeled to adjacent trunks. For example, adjacent trunk section may be configured such that redirected airflow from conduit 124 is channeled to hollow section 122 or 121 of a vertically adjacent trunk. In this manner, redirected airflow may be channeled vertically through both hollow sections 121 and 122.

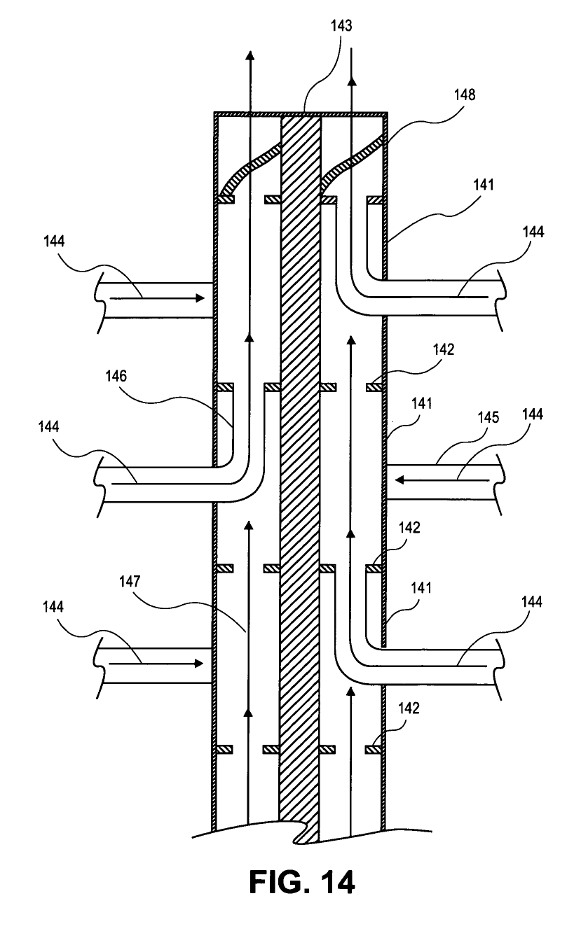

FIG. 14 shows an embodiment in which internal ducts of vertically adjoining trunks are fluidly connected and indicates the direction of airflow. Such vertically adjoining internal ducts may be used to channel the redirected airflow to act as a braking system, to an electrical generator, or vented away from the turbine. FIG. 14 shows multiple trunk sections 141 connected to multiple hubs 142, which are connected to rotating shaft 143. Redirected airflow 144 from the blades (not shown) enters trunks 141 from branch sections 145. Redirected airflow 144 becomes oriented vertically upward or downward by conduit 146 and becomes channeled into an adjoining trunk. Redirected airflow from lower trunk sections 147 is also channeled upward through adjoining trunks. Redirected airflow 144 and 147 become combined as they pass through adjoining trunks. At the top of the section, redirected airflow 144 and 147 impinge upon rotor 148, which is coupled to a generator (not shown). In this manner, a portion of the airflow incident upon the blades can be redirected to generate electrical power. In other embodiments, all or a portion of redirected airflow 144 and 147 may be vented from the turbine and/or may be coupled to a braking system. FIG. 14 shows redirected airflow being channeled vertically upward. A similar construction can be used to channel the redirected airflow vertically downward, for example, conduit 146 can be oriented downward, rather than upward as shown in FIG. 14.

In certain embodiments, an airflow control valve is disposed in the path of the redirected airflow, such as for example, in the funnel section of a cup or in the branch section. Various valves sensitive to air pressure are known in the art and may be used. Examples of useful airflow control valves include pressure-sensitive valves, poppet valves, flap valves, and centrifugal valves. An example of a pressure-sensitive airflow control valve is a spring-loaded airflow control valve. In certain embodiments, a valve response to centrifugal force may be used to control the volume of redirected airflow.

In wind turbines in which airflow is redirected, the internal conduits of adjoining trunks are fluidly connected such that airflow may pass from one trunk to an adjoining trunk. Each trunk may comprise a single air conduit or more than one air conduit. For example, one air conduit can receive airflow from the cup and branch to which it is connected, and another air conduit can pass airflow from an adjoining trunk to another adjoining trunk.

Redirected airflow may be vented, coupled to a braking system, and/or coupled to an electrical generator. Redirected airflow may be vented to minimize the potential for damage to the wind turbine under certain environmental conditions such as at either sustained or gusting high wind speeds. In such embodiments, at least a portion of the airflow incident on the blades may be redirected toward the top of the structure and vented away from the system. Redirected airflow may also be vented toward the bottom of the structure, however venting from the top of the structure may be more likely to minimize turbulence around the wind turbine. An airflow control valve may be situated in the path of the redirected airflow, which opens at a certain pressure to vent the redirected air from the system. For example, an airflow control valve may be located at the top of the rotating shaft and beneath the bonnet.

Alternatively, to minimize the potential for damage to the wind turbine, airflow may be redirected to a braking system such as a hydraulic braking system, which is coupled to the rotating shaft. The braking system can be used to slow or stop the rotating shaft depending on the velocity and/or volume of redirected airflow.

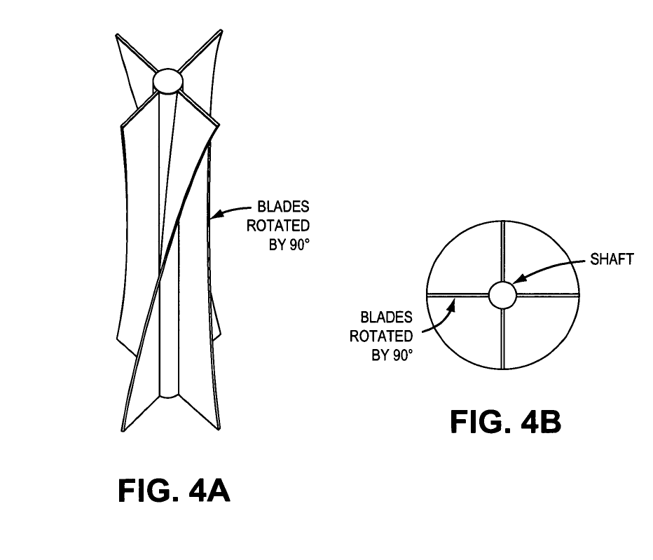

In certain embodiments, redirected airflow may be coupled to an electrical generator. Generators used to convert an airflow to electrical power are known and incorporate blade mechanisms and shaft within a shaft mechanisms. An example of a propeller for coupling diverted airflow to a generator is shown in FIG. 4. The propeller shown in FIG. 4 can be positioned within a tube through which the diverted airflow is directed.

The one or more rotating shafts of wind turbines provided by the present disclosure may be coupled to any appropriate electrical generator. Generators useful for generating electrical power in wind turbines are known in the art and may be used in the present systems. One or more electrical generators may be incorporated into a wind turbine at various locations on a rotating shaft as appropriate. A generator can be mounted on the bottom of a rotating shaft, at the top of a rotating shaft, and/or at a position along the length of the rotating shaft.

A generator may be coupled to a rotating shaft using gears. In other embodiments, the magnet or armature/coils may be mounted to a rotating shaft and the other of the magnet or armature/coils may be fixed. The fixed magnet or armature/coil may be mounted to the non-rotating frame, to the mount, or to another fixed assembly.

Wind turbines provided by the present disclosure may include one or more braking systems. For example, one braking system may be used to prevent the system from functioning during assembly and/or maintenance. A wind turbine may also comprise an active braking system that is responsive to an operational parameter of the system. For example, an active braking system may be responsive to the rotational speed of a rotating shaft such that the braking system is activated at high speeds to minimize the potential for mechanical damage to the wind turbine. A wind turbine may comprise a braking system that is response to the velocity or volume of redirected airflow. The velocity or volume of redirected airflow may be determined using an electronic sensor and the generated signal used to control the braking system.

Wind turbines provided by the present disclosure may be adapted to generate a desired power. For example, in certain embodiments, a wind turbine can generate a power from about 1 kW to about 300 kW, and in certain embodiments, from about 20 kW to about 175 kW. In certain embodiments, a wind turbine provided by the present disclosure can generate a power from about 1 kW to about 10 kW; from about 20 kW to about 50 kW; from about 50 kW to about 150 kW; and in certain embodiments, from about 150 kW to about 500 kW.

Wind turbines utilize energy inherent in the moving atmosphere, i.e., the wind. The amount of energy available from wind can be calculated based on principles of physics. The theoretical maximum amount of energy available from wind can be estimated as P=½ ρ A ν³, wherein P is the available power, ρ is the density of the air (about 1.2 kg/m²), A is the cross-sectional area applied to the turbine, and ν is the wind velocity. Wind turbines cannot extract 100% of the total wind energy and are restricted by a theoretical maximum performance known as the Betz limit. This limit states that the theoretical maximum amount of energy that can be extracted by a wind turbine is about 59% of the wind energy. Additional conversion loses such as bearing friction, gearing, and power conversion can limit the conversion efficiency to 50% or less of the theoretical maximum. Applying the above equation and assuming 50% conversion efficiency, a surface area of about 500 m² is required to produce about 150 kW of electrical power at a wind velocity of about 10 m/s, a surface area of about 250 m² is required to produce about 75 kW of electrical output power at a wind speed of about 10 m/sec, and so forth. For a wind velocity of about 8 m/sec, a surface area of about 975 m² is required to generate an output power of about 150 kW.

The surface area and the length of the blades of a wind turbine provided by the present disclosure may be selected based on the typical wind conditions at the site of use and on the desired output power. Small wind turbines comprising multiple blades attached to a single hub may be appropriate for low power systems of a few kW. Somewhat large wind turbines having a few hubs may be used in installations with higher output power requirements.

The modular design of wind turbines provided by the present disclosure can facilitate assembly and repair of systems in regular power increments. For example, modular sections comprising a rotating shaft, blades and hubs, and in certain embodiments a generator can be assembled to provide a nominal power of 1.5 kW. Systems with higher output power can be constructed by adding the 1.5 kW modular sections.

In view of aesthetic considerations at installation site, it may be desirable to match or adapt the general appearance of a wind turbine to the environment. Accordingly, in certain embodiments, a wind turbine provided by the present disclosure may have the generally arboreal appearances and shapes. Arboreal appearance and shape includes trees and shrubs. As can be appreciated there are many arboreal shapes and the overall appearance of wind turbines provided by the present disclosure are not limited to a particular appearance or shape. In general, for a wind turbine comprising a mount and a rotor section, the mount may simulate the appearance of a tree trunk, and the rotor section the branches and leaves of a tree. Accordingly, in certain embodiments, the rotor section may define/fill a generally conical area, a generally truncated conical area, a generally spherical area, or an irregularly shaped area. A particular shape of the rotor section can be determined by the dimension of the blades along the length of the rotating shaft. For example, a generally conical shaped structure may be accomplished by arranging the plurality of blades such that larger blades are generally disposed toward the bottom of the rotor section and smaller blades are generally disposed toward the top of the rotor section. As such, the blades may be disposed to fill a generally conical or truncated conical space. Similarly, to define a generally spherical shape, larger blades can be disposed toward the center of the rotor section, and smaller blades toward the top and bottom of the rotor section.

To further simulate the appearance of a tree, the separate elements of a wind turbine may be colored and/or textured to simulate the appearance of a tree. For example the mount section may be colored substantially brown, gray or other appropriate color and/or textured to simulate the appearance of a natural tree trunk. Similarly, blade sections may be colored and/or textured to simulate the appearance of branches and leaves or needles. For example, cups may be substantially green or other appropriate color or colors to simulate leaves or needles and the branch and trunk sections may be brown, gray, or other appropriate color and/or texture to simulate the appearance of a natural tree trunk. Specific color and texture schemes may be selected to match the general appearance of native trees or shrubs of the surrounding landscape at the installation site.

Finally, it should be noted that there are alternative ways of implementing the disclosures contained herein. Accordingly, the present embodiments are to be considered as illustrative and not restrictive, and the claims are not to be limited to the details given herein, but may be modified within the scope and equivalents thereof.

What is claimed is:

1. A vertical axis wind turbine comprising:
a first rotating shaft coupled to a first generator;
a first plurality of hubs connected to the first rotating shaft and vertically disposed at intervals along the length of the first rotating shaft; and
a first plurality of blades connected to each of the first plurality of hubs.

2. The wind turbine of claim 1, comprising:
a second rotating shaft coupled to a second generator;
a second plurality of hubs connected to the second rotating shaft and vertically disposed at intervals along the length of the second rotating shaft; and
a plurality of blades connected to each of the second plurality of hubs.

3. The wind turbine of claim 2, wherein each of the first plurality of blades and each of the second plurality of blades are both chosen from a Darrieus rotor and a Savonius rotor.

4. The wind turbine of claim 2, wherein each of the first plurality of blades is chosen from a Darrieus rotor and a Savonius rotor, and each of the second plurality of blades is chosen from the other of a Darrieus rotor and a Savonius rotor.

5. The wind turbine of claim 1, wherein from 2 to 12 blades are attached to each hub.

6. The wind turbine of claim 1, wherein at least some of the plurality of blades have different dimensions depending on the disposition of the blades along the length of the first rotating shaft.

7. The wind turbine of claim 1, which is of a substantially arboreal shape.

8. The wind turbine of claim 1, wherein at least some of the plurality of blades comprise:
a cup section connected to a branch section; and
a trunk connected to the branch section, wherein the trunk section is adapted to be mechanically connected to the hub.

9. The wind turbine of claim 8, wherein each of the plurality of blades comprises:
a cup section connected to a branch section; and
a trunk connected to the branch section, wherein the trunk section is adapted to be mechanically connected to the hub.

10. The wind turbine of claim 8, wherein the cup section is substantially shaped as a curved open-faced funnel.

11. The wind turbine of claim 8, wherein each of the cup section, the branch section, and the trunk section comprise an internal conduit adapted to divert at least a portion of an airflow incident on the cup section to provide a redirected airflow.

12. The wind turbine of claim 11, wherein the internal conduits of vertically adjoining trunks are fluidly connected.

13. The wind turbine of claim 11, wherein the redirected airflow is vented.

14. The wind turbine of claim 11, wherein the redirected airflow is coupled to a second generator.

15. The wind turbine of claim 11, wherein the redirected airflow is coupled to a braking system.

16. The wind turbine of claim 1, which generates a power from about 1 kW to about 300 kW.

17. A Savonius blade for redirecting a portion of an airflow incident upon the blade, comprising:
a cup section; and
a funnel section comprising an internal conduit fluidly connected to the cup section.

18. The Savonius blade of claim 17, comprising an airflow control valve disposed within the internal conduit.

19. The Savonius blade of claim 17, which provides a volume of redirected airflow that is about 10% to about 90% the total volume of the airflow incident on the cup section.

20. A vertical axis wind turbine, comprising:
a vertical rotating shaft coupled to a first generator;
a plurality of hubs connected to the rotating shaft and disposed at intervals along the length of the rotating shaft; and
a plurality of blades connected to the plurality of hubs, wherein at least some of the plurality of blades comprise an internal conduit adapted to divert a portion of an airflow incident on the plurality of blades to provide a redirected airflow.

21. The wind turbine of claim 20, comprising a second generator coupled to the redirected airflow.

22. The wind turbine of claim 20, comprising a braking system coupled to the redirected airflow.
